(19) United States
(12) Patent Application Publication
(10) Pub. No.: US 2009/0283007 A1
(43) Pub. Date: Nov. 19, 2009

(54) Nuclear locomotive

(76) Inventor: William Gregory Taylor, San Antonio, TX (US)

Correspondence Address: WILLIAM G. TAYLOR, 7815 CASTON PARK, SAN ANTONIO, TX, 78249, US

(21) Appl. No.: 12/152,245

(22) Filed: May 14, 2008

(51) Int. Cl. B60L 11/00; B60L 13/04; B60B 19/00

(52) U.S. Cl. 104/281; 180/65.31; 280/29

(57) ABSTRACT

This device is a magnetically levitated (maglev) locomotive powered by an onboard nuclear reactor. The locomotive carries a small portable nuclear reactor that heats a fluid to boiling, and passes it through electric turbine engines to produce electric power. The fluid/steam then recirculates through cooling radiators condensing it back to liquid before it passes back into the reactors again. The electric power is used to power and cool the onboard electromagnets, which oppose passive permanent magnets or magnetic coils in the roadbed. The onboard reactor is capable of providing greater electrical power than previously described maglev systems. This, in turn, provides greater power to the superconducting electromagnets, which translates into greater lift capacity and greater speed.

### REFERENCES CITED

U.S. PATENT DOCUMENTS

| | | |
|---|---|---|
| 7,134,396 | November 2006 | Ramu |
| 6,250,230 | June 2001 | Post |
| 6,044,770 | April 2000 | Davey |
| 5,722,326 | March 1998 | Post |
| 5,253,592 | October 1993 | Coffey |
| 5,222,437 | June 1993 | Shibata |
| 5,085,149 | February 1992 | Huson |
| 4,913,059 | April 1990 | Fujie |
| 4,779,538 | October 1988 | Fujiwara |
| 4,299,173 | November 1981 | Arima |
| 3,225,228 | December 1965 | Roshala |

### FIELD OF THE INVENTION

The device relates to a specific method of land based vehicle propulsion.

### DESCRIPTION OF PRIOR ART

The current state of the art for land travel uses electric powered maglev trains. These trains are Levitated, propelled, and guided by setting superconducting electromagnets in opposition to magnetic elements in the roadbed. There are a large number of proposals for the ideal configuration of magnetic elements in the system. Most of these systems employ onboard superconducting electromagnets opposing various configurations of roadway stators to achieve levitation, propulsion and guidance of the vehicle.

The weight levitated and the speed of propulsion are directly proportional to the power of the electromagnets. This, in turn, is determined by the electrical power generated onboard and delivered to the electromagnets. The usual means of power production is a diesel powered electrical generator.

### OBJECT OF THE INVENTION

It is the object of this invention to provide a power source for a maglev vehicle system that allows vehicle propulsion at speeds far in excess of what is currently available.

### BRIEF SUMMARY OF THE INVENTION

This application provides for a vehicle that utilizes electric power provided by one or more onboard nuclear reactors. The vehicle is levitated, propelled, and guided in a manner similar to a standard maglev train, except that in this application the superconducting electromagnets operate at much higher strength due to the greater electrical output from the generators on the vehicle. In the current art, the speed and lift capacity of the vehicle are determined by the power supplied from diesel powered electrical generators, which, in turn, limits the field strength of the electromagnets.

The current application would provide for a considerably wider vehicle that is in current use, perhaps in the range of ten meters. The wider vehicle would provide appropriate space for the nuclear reactors, turbines and condensers; as well as greater stability and versatility for large cargo.

### BRIEF DESCRIPTION OF THE SEVERAL VIEWS OF THE DRAWINGS

FIG. 1 is a schematic view of the vehicle showing the vehicle (1) with the cooling radiator (2) connected to the nuclear reactor (3) with the steam outflow tubes (4) directed to the electrical turbine generators (5) and the steam return tubes (6) returning to the cooling radiator unit (2). The electrical power cables (7) are shown exiting the generators.

FIG. 2 is a schematic view of the vehicle (1) as it sits in a levitated position over the roadbed (8). Imbedded in the roadbed are the passive magnets (9), which are opposed by the actively powered electromagnets (11), incorporated in the vehicle.

FIG. 2 also shows the electric power cables (7) that connect the electric generators to the active electromagnets of the vehicle.

FIG. 2 also shows the retractable wheel system (10) upon which the vehicle rides at slow speeds without the levitation functions engaged.

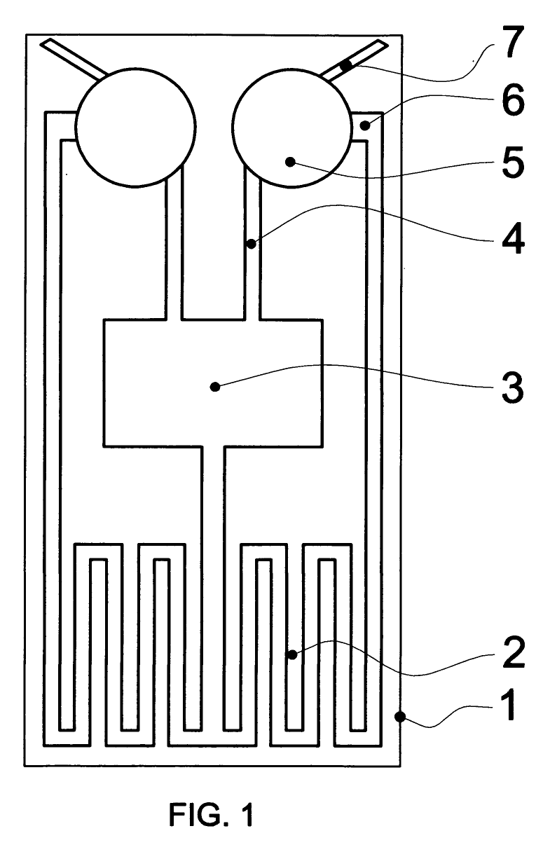

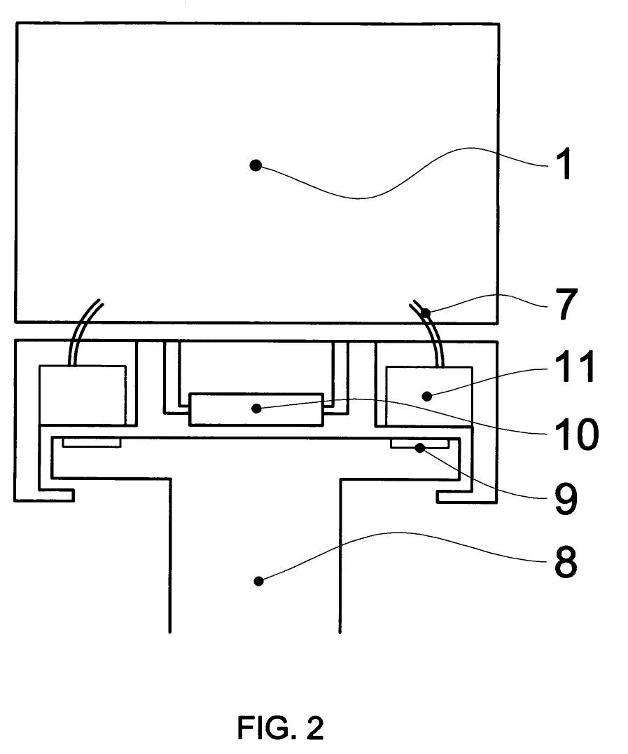

### DETAILED DESCRIPTION OF THE INVENTION

The object of this invention is a vehicle that travels along a specifically designed roadbed. This vehicle is propelled, levitated, and guided by opposing magnetic forces on the vehicle and in the roadbed. The power source for the superconducting electromagnets is the onboard electrical generator. This generator is run by an onboard nuclear reactor.

There are numerous configurations for the various elements of the maglev system that have been previously described. The system described here is unique in that it offers greater speed and greater lift capacity due to the incorporation of an onboard nuclear power generator.

What is claimed is:

1. A vehicle powered by electricity generated by one or more onboard nuclear reactors.

2. The device according to claim 1, wherein the nuclear reactors are fitted with a closed system of steam production and condensation back to a fluid state.

3. The device according to claim 1, wherein the electricity generated is directed to onboard electromagnets that induce a magnetic pole in said magnets.

4. The device according to claim 1, wherein the said electromagnets are designed to have a pole opposite to those embedded in the underlying roadbed.

5. The device rides over a custom designed roadbed.

6. The roadbed according to claim 5, wherein the roadbed is embedded with passive magnets or stators of opposite pole to those in said vehicle.

7. The device according to claim 1, wherein the vehicle is equipped with a set of retractable wheels.

8. The device according to claim 1, wherein the retractable wheels can be used when the electromagnetic levitation and propulsion systems are not in use.
